(19) United States
(12) Patent Application Publication
(10) Pub. No.: US 2015/0320061 A1
(43) Pub. Date: Nov. 12, 2015

(54) PROCESS FOR PREPARING STRAINED FERMENTED DAIRY PRODUCT

(71) Applicants: COMPAGNIE GERVAIS DANONE, Paris (FR); DANONE S.A., Barcelona (ES)

(72) Inventors: Françoise Warin, Madrid (ES); Paola Flabbi, Madrid (ES); François Corret, Vincennes (FR); Almuden Bilbao, Madrid (ES); Denis Paquet, Clamart (FR); Pascal Crepel, Gif Sur Yvette (FR); Laurent Marchal, Villemoisson-Sur-Orge (FR)

(21) Appl. No.: 14/763,030

(22) PCT Filed: Jan. 25, 2013
(86) PCT No.: PCT/IB2013/000162

§ 371 Date: Jul. 23, 2015

(51) Int. Cl. A23C 9/123; A23C 9/133

(52) U.S. Cl. CPC A23C 9/1238; A23C 9/1234; A23C 9/133; A23Y 2220/29; A23Y 2240/75

(57) ABSTRACT

The present invention relates to a process for the manufacture of a strained fermented dairy product, comprising a heat treatment step, a high pressure homogenization step, a fermentation step, a separation step and a smoothing step.

The present invention relates to the field of strained/concentrated fermented dairy product and its process of preparation. The invention further relates to a process for the preparation of strained fermented dairy products with improved texture.

The strained fermented dairy products are well known, in particular in Europe under the name of the Greek style yogurt or “thick” yogurt. Generally, these products have a high fat content (around 10 g/100 g) and they are placed in the category of greedy products with a creamy flavor. It is a pervasive goal in the human diet to consume less fat; and the relative high fat content of a typical Greek style yogurt is not helpful in achieving this goal. Countless attempts have been made to make a low fat Greek style yogurt, but the resulting products on the market are not satisfactory in term of taste, appearance and texture. Different methods can be used for the manufacture of strained fermented dairy products. The different methods available to manufacture strained yogurt in large volume are as follows: cloth bag or the “berge” system, mechanical separators and ultrafiltration. Generally, Greek style yogurts are manufactured from only pasteurized milk and lactic acid bacteria cultures. The milk may be concentrated by ultrafiltration to remove a portion of the water before addition of lactic acid bacteria. After fermentation, the product may be centrifuged or membrane-filtered to remove whey. It is known from literature that yogurt may be subjected to an ultrafiltration process to increase the solids as required in certain types of yogurt such as Greek-style yogurt. This technology was borrowed from the cheese technology. For example, WO9827825 describes a method for preparing fresh cheese with a smooth texture and more than 13% of dry matter, which consists in: fermenting milk with at least a strain of thermophilic lactic bacterium, until a pH less than 4.9 is reached for obtaining a curd, and removing the resulting whey by continuous centrifugation.

However, surprisingly with the complete combined process developed and described in this invention, whose parameters have been clearly defined, the obtained strained fermented dairy products have an improved texture and excellent organoleptic properties.

Today, there is a need for a strained fermented dairy product combining a low fat content, a high protein content, a low acid taste, a good texture and a good stability in the time. In other words, the strained fermented dairy products according to the invention are complex, because they need to have in combination: a low fat content, a high protein content, a higher viscosity than standard yogurts, a weak post acidification in the end of the shelf life, a good lactic acid bacteria count until the end of the shelf life and excellent organoleptic properties. Excellent organoleptic properties consist in a creamy, a low acid and low astringent taste (the acidity in the mouth is considerably reduced) even with a low fat content and a good texture in spoon and in mouth.

The present invention provides a process for the manufacture of a strained fermented dairy product, comprising at least the following steps:
(a) a heat treatment step at a temperature of 75 to 95° C. for 2 to 15 min, followed or preceded by a high pressure homogenization step at a pressure of from 20 bars to 300 bars, in particular from 50 bars to 250 bars, of a dairy material,
(b) a fermentation step of the product obtained in (a) at a temperature of from 30 to 44° C., preferably of from 36 to 42° C.,
(c) a separation step of the product obtained in (b) wherein said separation step is performed by a separator at a temperature of from 30 to 45° C., to obtain a strained fermented dairy product wherein the total protein content is between 6 and 14 g/100 g of product, in particular 8 and 11 g/100 g of product,
(d) a smoothing step of the product obtained in (c) performed by a rotor stator mixer, in particular at a temperature of from 30° C. to 45° C.

In a preferred embodiment, the dairy material has a fat content of from 0 to 2%, in particular from 0.05 to 1%, more particularly from 0.1 to 0.3% by weight and a protein content of from 3 to 4.6%, in particular from 3.1 to 4%, more from 3.2 to 3.6% by weight.

In the context of the invention, the expression “dairy material” refers to milk, milk derivate or mixtures thereof. The milk is selected from raw milk, skimmed milk, semi-skimmed milk, fat-enriched milk, and mixtures thereof. The milk derivate is selected from milk powder, skimmed milk powder, milk proteins, milk protein concentrate, concentrated milk, milk cream and mixtures thereof. The dairy material to be used in the method of the invention can derive from any milk such as cow's milk, sheep's milk, goat's milk. In a preferred embodiment of the process of the invention, the dairy material comes from cow's milk.

In a particular embodiment, the high pressure homogenization precedes the heat treatment step. The high pressure homogenization step is typically performed in an equipment appropriate which can be selected by the skilled in the art. Preferably, the high pressure homogenization step is performed by compressing at a high pressure a stream of material in a chamber, then by decreasing instantaneously the pressure by letting the stream of material going through a small gap between a cylinder and a valve. This applies a high shearing on the material. This process is continuous and applied by a large variety of equipments called high pressure homogenizers. The homogenization step, according to the invention, seems to make it possible to improve the separation step. It was noted in the invention, that the protein concentration (the rate of protein enrichment) in the step of separation (c) is improved when the homogenization step is performed, according to the invention.

In a particular embodiment, the fermentation step is done with yogurt bacteria, Streptococcus thermophilus and Lactobacillus delbrueckii subsp. bulgaricus. Optionally, the fermentation step also includes the addition of other lactic acid bacteria, such as Bifidobacterium and/or Lactobacillus acidophilus and/or Lactobacillus casei and/or Lactobacillus rhamnosus and/or Lactobacillus reuteri and/or Lactobacillus johnsonii and/or Lactobacillus plantarum and/or Lactobacillus helveticus and/or Lactobacillus fermentum and/or Lactobaciluus amylovorus and/or Lactoccocus lactis and/or Leuconostoc mesenteroides. After inoculation of the dairy material, fermentation is conducted under the usual conditions suitable for growth of the inoculated bacteria. The fermentation is stopped when the fermentation medium reaches the desired target pH, in particular from 4 to 4.8, preferably 4.6. It is well known in the literature that starter cultures are primarily responsible for the production of the flavor compounds which contribute to the aroma of yoghurt. There is a general agreement that the aroma of flavor of yoghurt is basically due to the production of acetaldehyde and other unidentifiable compounds. Some other strains like the ones mentioned above can improve the organoleptic properties of yoghurt. In particular, Lactococcus lactis subsp. lactis produces diacetyl known to bring a creamy flavor in product. It was surprisingly found that the process according to the present invention makes it possible to produce a strained fermented dairy product having better taste (low acidic off notes, high creamy note . . . ) without using other lactic acid bacteria such as Bifidobacterium, Lactobacillus acidophilus, Lactobacillus casei, Lactobacillus rhamnosus or mesophilic lactic acid bacteria such as Lactoccocus lactis known to improve the flavor of the product.

The separation step, according to the invention, describes a step of concentration of the solids of the product, in particular proteins to a desired solids or protein content (% by weight). The term “separator” designates a device selected among the group of equipments applying the following operation: reverse osmosis, ultrafiltration, centrifugal separation, and any device allowing to withdraw a part of the water or whey from the product.

In the context of the present invention, the “total protein content” means the total amount of milk proteins contained in the product. In particular, the separation step is performed to obtain a total protein content at the end of this step between 6 and 14 g/100 g of product, in particular 8 and 11 g/100 g of product. It has been noted by the inventors that the process according to the invention makes it possible to produce a strained fermented dairy product with a good viscosity and texture related to the presence of a protein content in the range above mentioned.

In a preferred embodiment, the separation step is performed until a rate of protein enrichment of 2 to 3 times the protein content of the dairy material. In the context of the present invention, the “rate of protein enrichment” means that the protein content of the initial dairy material is increased by 2 to 3 times. The skilled in the art can perfectly determine the protein content of the dairy material used and the protein content of the product obtained in (c).

In the present invention, the smoothing step is done by a rotor stator mixer. An example of description of this equipment is done in the patent application WO2007/095969. In the context of the invention, “rotor stator mixer” means an equipment in which the product goes through cogged rings, a part of the rings being static, the remaining part being in rotation at a set speed. This system of cogged rings partly static or in rotation applies a defined shearing to the product. Preferably, the rotor stator mixer comprises a ring shaped rotor and a ring shaped stator, each ring of the rotor and the stator being provided with radial slots having a given width, comprising adjusting the rotational speed of the rotor to adjust the peripheral velocity. The rotor may be operated so that the peripheral velocity is between 2 m/s and 13 m/s, in particular between 3 m/s and 5 m/s and more particularly between 3.6 m/s and 4 m/s.

In a preferred embodiment, the process according to the invention comprises a heat treatment of the product obtained in (b) at a temperature of from 50 to 65° C. during from 1 to 10 min, in particular at a temperature of 58° C. during 2.5 min.

In a more preferred embodiment, the process according to the invention comprises after the smoothing step (d), a cooling step of the product obtained in step (d) at a temperature of from 15 to 20° C.

In a particular embodiment, the process according to the invention comprises after the smoothing step (d) and optionally after the cooling step, a step of addition of a cream material and/or a fruit preparation.

In the context of the invention, the “cream material” is selected among the group of: cream, mixture of milk and cream. In the context of the invention, the “fruit preparation” is selected among the group: fruit pieces in a matrix, fruit puree in a matrix, fruit puree, concentrated fruit puree, fruit compote, fruit juice, dried fruits. The fruit are selected from the group consisting of strawberry, blackberry, apricot, peach, raspberry, blueberry, pineapple, mango, banana, papaya, passion fruit, plum, pomelo, orange, kiwi, lemon, cherry, pear and apple.

In a particular embodiment, the cream material has a fat content of from 20 to 50% by weight, in particular from 23 to 40% by weight.

In a preferred embodiment, the cream material is prepared by at least the following steps:
pre-heating at a temperature of 75 to 95° C., preferably of 75° C. to 90° C.,
homogenization of the pre-heated material obtained, in a single step at a pressure of 150 bars,
heat treatment at 75 to 142° C. for 10 sec to 6 min,
cooling at 4 to 10° C.

In the context of the present invention, the cream material is stored at 4 to 10° C. for 1 to 48 hours.

In a more preferred embodiment, the process according to the invention, comprising at least the following steps:
a pre-heat treatment step at a temperature of from 75 to 95° C. of a dairy material,
a homogenization step at a pressure of from 20 bars to 300 bars, in particular from 25 bars to 300 bars, in particular from 50 bars to 250 bars, of the said dairy material,
a heat treatment step at a temperature of from 90 to 95° C. for 2 to 7 min,
a fermentation step with at least Streptococcus thermophilus and Lactobacillus delbrueckii subsp. bulgaricus at a temperature of from 30 to 44° C., preferably of from 35 to 44° C., preferably of from 36 to 42° C., during 4 to 7 hours,
a heat treatment step at a temperature of from 50 to 65° C. during from 1 to 10 min, in particular at a temperature of 58° C. during 2.5 min,
a separation step wherein said separation step is performed by a separator at a temperature of from 30 to 45° C., to obtain a strained fermented dairy product wherein the total content of protein is between 6 and 14 g/100 g of product, in particular 8 and 11 g/100 g of product,
a smoothing step performed by a rotor stator mixer, in particular at a temperature of from 30° C. to 45° C.,
a cooling step to a temperature of from 15 to 20° C.

A strained fermented dairy product is collected at the end of the process above mentioned.

In an additional embodiment, the process according to the invention is characterized by an addition step of a cream material and/or a fruit preparation. In this context, the strained fermented dairy product obtained has a fat content of from 0.5 to 5% by weight, in particular from 2 to 2.9% by weight.

The present invention also concerns a strained fermented dairy product obtainable by the process according to the invention, comprising by weight of final product:
from 0 to 5% of fat, in particular from 2 to 3.5% of fat, more particularly 2.9% of fat, and
from 6 to 12% of proteins, in particular from 7 to 10% of proteins, more particularly 9% of proteins,
wherein said strained fermented dairy product:
has from 1·10⁵ to 3·10⁶ cfu/ml of Lactobacillus delbrueckii subsp. bulgaricus and from 1·10⁸ to 3·10⁹ cfu/ml of Streptococcus thermophilus during all the shelf life, in particular during 28 days
has a pH of from 3.9 to 4.4, in particular of from 3.95 to 4.3, more particularly of from 4 to 4.2,
has a viscosity from 2000 to 7000 mPa·s⁻¹, in particular from 2200 to 6500 mPa·s⁻¹, more particularly from 2500 to 6000 mPa·s⁻¹, measured with a Rheomat RM 200 at a temperature of 10° C. and at a shear of 64 s⁻¹.

It has been noted by the inventors that the strained dairy product already disclosed or available to date have an acidity too high to be suitable for the taste of Westerns consumers, in particular European consumers. Consequently, the inventors sought to develop formulas with a sufficient viscosity and a less acid and more pleasant taste, for the consumer. In this context, they found that the acidity taste can be mitigated under certain specific conditions of formulas and process. The strained fermented dairy product according to the invention presents a low fat content, a high protein content, a higher viscosity than standard yogurts, a weak post acidification in the end of the shelf life, a good lactic acid bacteria count until the end of the shelf life and excellent organoleptic properties. Excellent organoleptic properties consists in a creamy, a low acid and low astringent taste (the acidity in the mouth is considerably reduced) even with a low fat content and a good texture in spoon and in mouth.

In a preferred embodiment, the strained fermented dairy product according to the invention comprises a white mass content of from 75 to 99.99% by weight. By “white mass” is meant dairy material.

In a more preferred embodiment, the strained fermented dairy product according to the invention comprises a acid bacteria culture content of from 0.001 to 0.5% by weight.

In a particular embodiment, the strained fermented dairy product according to the invention comprises a fruit preparation, wherein the fruits are selected from the group of cherry, strawberry, peach, blueberry, pineapple, raspberry, apricot, coconut, passion fruit, apple or a mixture.

The strained fermented dairy product according to the invention can have from 0 to 25% by weight of fruit preparation.

In a more particular embodiment, the strained fermented dairy product according to the invention comprises a cream material with a fat content of from 20 to 50% by weight, in particular from 23 to 40% by weight.

In an even more particular embodiment, the strained fermented dairy product according to the invention has fat globules with an average diameter in the range from 0.05 to 10 μm, in particular from 1 μm to 2.5 μm.

Preferably, the strained fermented dairy product further comprises at least one additive chosen among sweeteners, flavors, flavor enhancers, sugar, preservatives and combinations thereof. More preferably, the strained fermented dairy product is packaged in format size from 100 to 500 g.

### FIGURES

This invention is illustrated by the following figures:

FIG. 1 represents the kinetics of viscosity of the products A, B, C, D and E. The ordinate corresponds to the viscosity (mPa·s⁻¹) and the abscissa corresponds to the time (in days).

FIG. 2 represents the kinetics of pH of the products A, B, C, D and E. The ordinate corresponds to the pH and the abscissa corresponds to the time (in days).

FIG. 3 represents the count of bacteria in a strained fermented dairy product, inoculated with Streptococcus thermophilus (ST) and Lactobacillus delbrueckii subsp. bulgaricus (LB). The ordinate corresponds to the count (cfu/ml) and the abscissa corresponds to the time (in days). The black histogram is the count of Streptococcus thermophilus. The gray histogram is the count of Lactobacillus delbrueckii subsp. bulgaricus. The dark gray histogram is the total count of bacteria.

FIG. 4 represents the sensory profile of a strained fermented dairy product according to the invention (fat content 3.5%) and several commercial strained fermented dairy products (fat content 5%). The black line corresponds to the sensory profile of the product according to the invention. The gray zone corresponds to the sensory space of several commercial strained fermented dairy products.

Various embodiments of the present invention are illustrated in the following examples, which are intended to illustrate, without in any way limiting, the object and the scope of the invention.

### EXAMPLES

Strained fermented dairy products were prepared according to the process of the invention. The products had the following characteristics.

1) Viscosity and pH of Strained Fermented Dairy Products Prepared According to the Invention

| | Prod- | Prod- | Prod- | Prod- | Prod- |
|---|---|---|---|---|---|
| | uct A | uct B | uct C | uct D | uct E |
| Protein | 9.8% | 9.4% | 9.4% | 9.4% | 9.4% |
| content | | | | | |
| (% by | | | | | |
| weight | | | | | |
| of final | | | | | |
| product) | | | | | |
| Fat content | 0% | 2% | 2% | 2% | 2% |
| (% by | | | | | |
| weight | | | | | |
| of final | | | | | |
| product) | | | | | |
| Flavors | — | — | Va- | Straw- | Blue- |
| | | | nilla | berry | berry |
| Viscosity | 2625 | 2632 | 3408 | 3332 | 3563 |
| after 1 day | | | | | |
| (mPas · s) | | | | | |
| Viscosity | 5600 | 3228 | 4639 | 5816 | 5033 |
| after 50 days | | | | | |
| (mPas · s) | | | | | |
| pH Day 1 | 4.28 | 4.30 | 4.29 | 4.26 | 4.27 |
| pH Day 50 | 4.08 | 3.94 | 4.07 | 4.04 | 4.01 |
| Dornic | 146 | 129 | — | — | — |
| acidity | | | | | |
| after 1 Day | | | | | |
| Dornic | 170 | 142 | — | — | — |
| acidity | | | | | |
| after | | | | | |
| 45 Days | | | | | |

The viscosity has been measured with a Rheomat RM 200 at a shear rate of 64 s-1 and at 10° C.

The pH has been measured at 10° C. with a classical laboratory equipment.

The dornic acidity has been measured at 10° C. with add of NaOH 0.1N until pH 8.35.

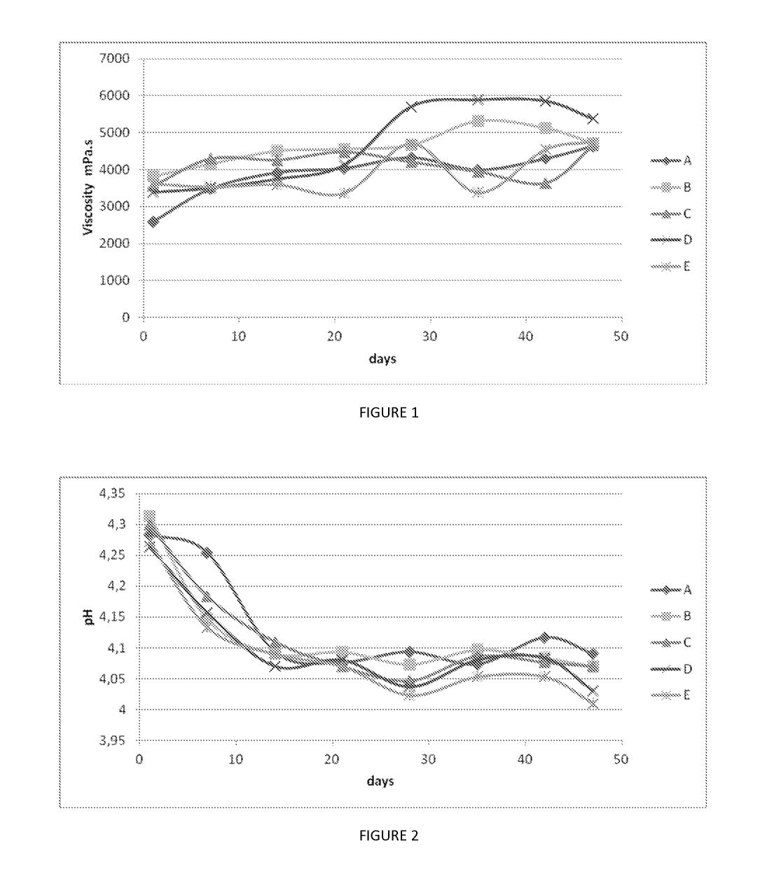

The results are illustrated by FIGS. 1 and 2.

2) Count of Bacteria (Cfu/Ml)

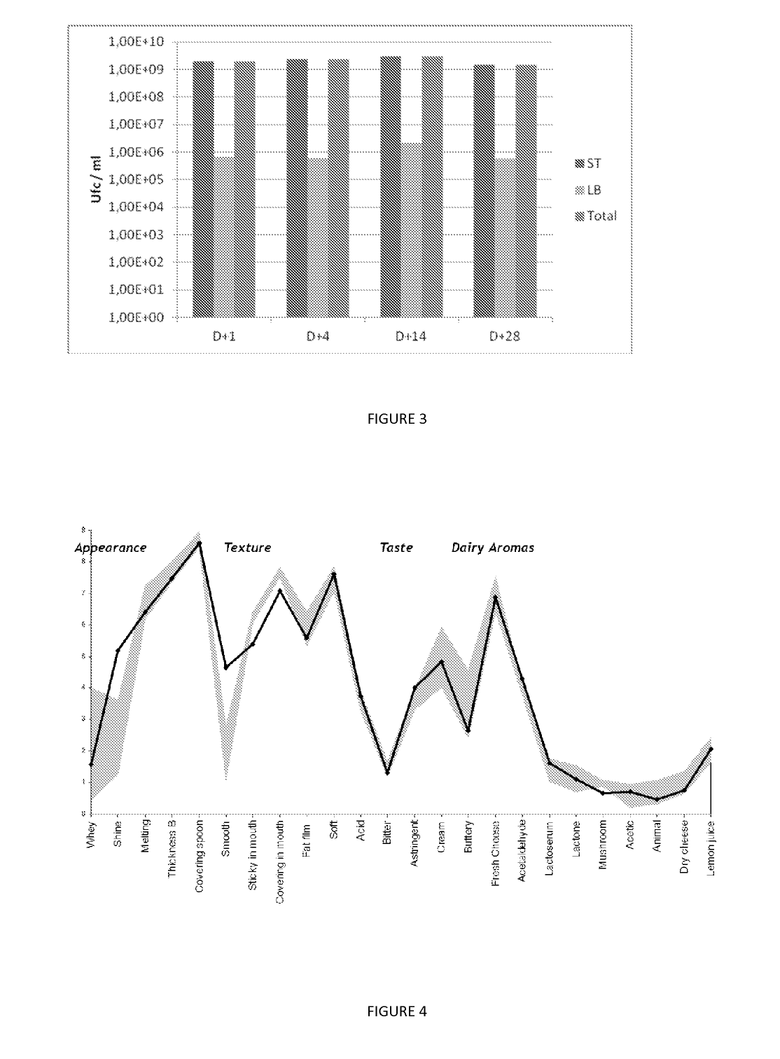

The count of bacteria has been done on a strained fermented dairy product prepared with a step of heat treatment (at a temperature of 58° C. during 2.5 minutes) after the step of fermentation. The results are shown in FIG. 3.

3) Sensory Profile

The strained fermented dairy product of the invention (X) and commercial strained fermented dairy products (Y) were analysis.
Product (X): 3.5% of fat content
Product (Y): 5% of fat content

Analysis criteria: appearance, texture, taste, dairy aroma. For each criteria, characteristics are quantified (for example: smooth, sticky, acidic taste, cream note . . . . )

The results are shown in FIG. 4.

1. A process for the manufacture of a strained fermented dairy product, comprising at least the following steps:
(a) a heat treatment step at a temperature of 75 to 95° C. for 2 to 15 min, followed or preceded by a high pressure homogenization step at a pressure of from 20 bars to 300 bars, in particular from 50 bars to 250 bars, of a dairy material,
(b) a fermentation step of the product obtained in (a) at a temperature of from 30 to 44° C., preferably of from 36 to 42° C.,
(c) a separation step of the product obtained in (b) wherein said separation step is performed by a separator at a temperature of from 30 to 45° C., to obtain a strained fermented dairy product wherein the total protein content is between 6 and 14 g/100 g of product, in particular 8 and 11 g/100 g of product,
(d) a smoothing step of the product obtained in (c) performed by a rotor stator mixer, in particular at a temperature of from 30° C. to 45° C.

2. The process according to claim 1, wherein the dairy material has a fat content of from 0 to 2%, in particular from 0.05 to 1%, more particularly from 0.1 to 0.3% by weight.

3. The process according to claim 1, wherein the dairy material has a protein content of from 3 to 4.6%, in particular from 3.1 to 4%, more particularly from 3.2 to 3.6% by weight.

4. The process according to claim 1, further comprising a heat treatment of the product obtained in (b) at a temperature of from 50 to 65° C. during from 1 to 10 min, in particular at a temperature of 58° C. during 2.5 min.

5. The process according to claim 1, further comprising after the smoothing step (d), a cooling step of the product obtained in step (d) to a temperature of from 15 to 20° C.

6. The process according to claim 1, further comprising after the smoothing step (d) and optionally after the cooling step, a step of addition of a cream material and/or a fruit preparation.

7. The process according to claim 1, wherein the cream material has a fat content of from 20 to 50% by weight, in particular from 23 to 40% by weight.

8. The process according to claim 1, wherein the cream material is prepared by at least the following steps:
pre-heating at a temperature of 75 to 95° C.,
homogenization of the pre-heated material obtained, in a single step at a pressure of 150 bars,
heat treatment at 75 to 142° C. for 10 sec to 6 min,
cooling at 4 to 10° C.

9. The process according to claim 1, comprising at least the following steps:
a pre-heat treatment step at a temperature of from 75 to 95° C. of a dairy material,
a homogenization step at a pressure of from 25 bars to 300 bars, in particular from 50 bars to 250 bars, of the said dairy material,
a heat treatment step at a temperature of from 90 to 95° C. for 2 to 7 min,
a fermentation step with at least Streptococcus thermophilus and Lactobacillus delbrueckii subsp. bulgaricus at a temperature of from 35 to 44° C., preferably of from 36 to 42° C., during 4 to 7 hours,
a heat treatment step at a temperature of from 50 to 65° C. during from 1 to 10 min, in particular at a temperature of 58° C. during 2.5 min,
a separation step wherein said separation step is performed by a separator at a temperature of from 30 to 45° C., to obtain a strained fermented dairy product wherein the total content of protein is between 6 and 14 g/100 g of product, in particular 8 and 11 g/100 g of product,
a smoothing step performed by a rotor stator mixer, in particular at a temperature of from 30° C. to 45° C.,
a cooling step to a temperature of from 15 to 20° C.

10. The strained fermented dairy product obtainable by the process according to claim 1, comprising, by weight of final product:
from 0 to 5% of fat, in particular from 2 to 3.5% of fat, more particularly 2.9% of fat, and
from 6 to 12% of proteins, in particular from 7 to 10% of proteins, more particularly 9% of proteins,
wherein said strained fermented dairy product:
has from 1·10⁵ to 3·10⁶ cfu/ml of Lactobacillus delbrueckii subsp. bulgaricus and from 1·10⁸ to 3·10⁹ cfu/ml of Streptococcus thermophilus during all the shelf life, in particular during 28 days
has a pH of from 3.9 to 4.4, in particular of from 3.95 to 4.3, more particularly of from 4 to 4.2,
has a viscosity from 2000 to 7000 mPa·s⁻¹, in particular from 2200 to 6500 mPa·s⁻¹, more particularly from 2500 to 6000 mPa·s⁻¹, measured with a Rheomat RM 200 at a temperature of 10° C. and at a shear of 64 s⁻¹.

11. The strained fermented dairy product according to claim 10, having a white mass content of from 75 to 99.99% by weight.

12. The strained fermented dairy product according to claim 10, having a lactic acid bacteria culture content of from 0.001 to 0.5% by weight.

13. The strained fermented dairy product according to claim 10, comprising a fruit preparation, wherein the fruits are selected from the group of cherry, strawberry, peach, blueberry, pineapple, raspberry, apricot, coconut, passion fruit, apple or a mixture.

14. The strained fermented dairy product according to claim 10, having fat globules with an average diameter in the range from 0.05 to 10 μm, in particular from 1 μm to 2.5 μm.
